(19) United States
(12) Patent Application Publication
(10) Pub. No.: US 2011/0012870 A1
(43) Pub. Date: Jan. 20, 2011

(54) Thumb Retained Stylus for Interfacing with a Handheld Device Such as a Mobile Phone

(76) Inventor: Saulo Pena, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 12/505,727

(22) Filed: Jul. 20, 2009

(51) Int. Cl. G06F 3/033

(52) U.S. Cl. 345/179

(57) ABSTRACT

A thumb-retained stylus for effecting operative contact with the interface of a handheld device is disclosed. The thumb-retained stylus includes a thumb-mounting device and a curved stylus which extends laterally therefrom. The curved stylus is oriented for effecting operative contact with an interface of a handheld device. The interface could be physical buttons or the keypad, keyboard or navigation buttons depicted on a touch screen of a mobile phone or PDA.

### FIELD OF THE INVENTION

The present invention relates generally to a thumb-mounted device designed to interact with the physical buttons or the touch screen navigation buttons of a handheld or portable computer such as a mobile phone or a personal digital assistant (PDA).

### BACKGROUND OF INVENTION

Handheld electronic devices have been shrinking for years and many users are having trouble with the ever-decreasing size of physical buttons and touch screen navigation buttons of such devices. Such buttons on computing devices, which seem to get smaller every year, are often difficult to operate accurately. Due to increasingly smaller sizes, users often actuate an unintended button or select the wrong menu option on mobile phones or PDAs. Ergonomists who have studied such handheld devices have suggested that the buttons and menu options on such devices are more suited to the hands of young children rather than full grown adults.

Also, fingertips are often unduly large and/or blunt and a user often cannot position his or her finger or thumb with sufficient accuracy to locate a desired physical button or touch screen navigation button, especially when actuating buttons or menu selections in rapid succession, such as when composing a text message. Often the user may inadvertently actuate an incorrect button resulting in typing errors, wasted time, and indecipherable sent text messages.

The device of the present invention provides a solution to these problems by providing a design that reduces stress on fingers and thumbs, and improves the speed and accuracy of typing and texting. The device of the present invention fits over a user's thumbs and provides a smaller stylus that is free of dirt, perspiration and oil, for actuating physical buttons or touch screens. The stylus extends laterally from the thumbs to prevent obstructing the user's view of the buttons or menu options during typing or texting. Using the present invention increases speed and accuracy during typing and texting.

### SUMMARY OF THE INVENTION

A thumb-retained stylus for effecting operative contact with the interface of a handheld device is disclosed. The thumb-retained stylus includes a thumb-mounting device and a curved stylus which extends laterally therefrom. The curved stylus is oriented for effecting operative contact with an interface of a handheld device. The interface could be physical buttons or the keypad, keyboard or navigation buttons depicted on a touch screen of a mobile phone or PDA.

### BRIEF DESCRIPTION OF THE DRAWINGS

FIG. 1 is a perspective view of the thumb-retained stylus of the present invention situated over a user's thumb for actuating buttons on handheld devices;

FIG. 2 is an elevational view of the thumb-retained stylus of the present invention; and,

FIG. 3 is an elevational view of the thumb-retained stylus of the present invention.

### DETAILED DESCRIPTION OF THE INVENTION

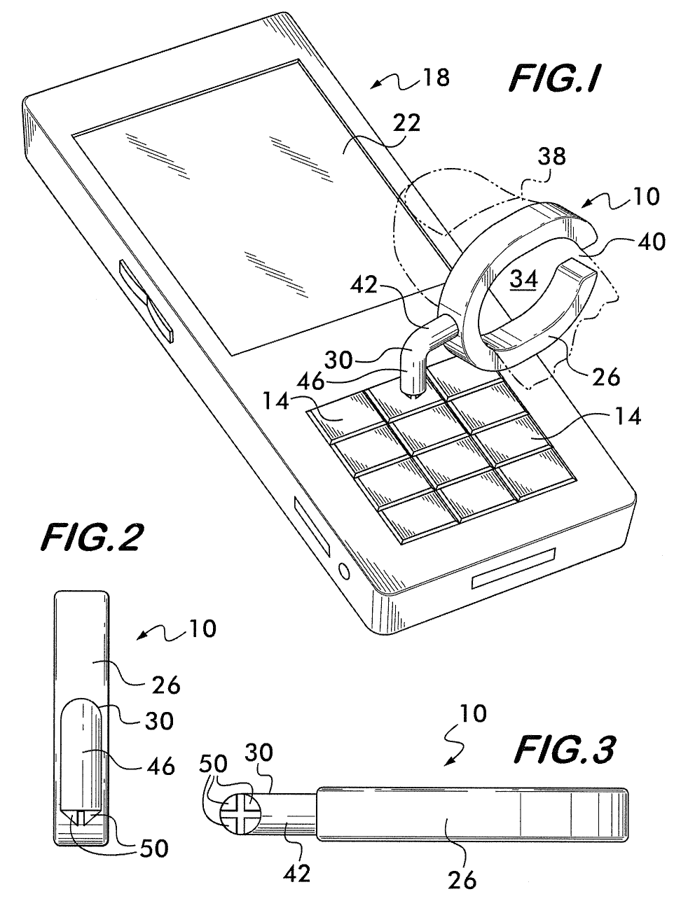

Referring now in detail to the various figures of the drawings wherein like reference characters refer to like parts, there is shown at 10 in FIGS. 1-3, the thumb-retained input device of the present invention. The device 10 is shown being used for actuating the interface of a handheld device. The exemplary handheld device shown in FIG. 1 is a mobile phone 18 having an interface comprised of a series of physical buttons 14. The size of the buttons 14 are shown as being greater in width than in height. However, it should be understood that the device 10 of the present invention is equally suited for use on handheld devices where the size of the buttons 14 are greater in height than in width, or other configurations and shapes. In addition to the physical buttons 14, the mobile phone 18 includes a screen display 22 and other components familiar to end users and those having skill in the art. It should also be understood that although not shown in the figures, the device 10 of the present invention is equally suited for use with other handheld devices such as a PDA having a touch screen comprised of a plurality of navigation buttons or menu selections having different configurations.

As shown in FIG. 1, the thumb-retained input device 10 comprises a thumb-mounting device 26 having a curved stylus 30 projecting laterally therefrom. The mounting device 26 is preferably in the shape of a ring having an aperture 34 designed to receive a thumb 38 (shown in phantom). It should be understood that the thumb-retained input device 10 shown in FIG. 1 is arranged for receiving a user's right thumb 38 with the curved stylus 30 extending laterally in the medial direction. Likewise, a mirror image (not shown) of the thumb retained input device 10 could be arranged or adapted for receiving a user's left thumb wherein the curved stylus 30 could extend laterally from a mounting device 26 in the medial direction, i.e., to the right of the user's left thumb. In other words, when worn on a user's opposed thumbs, the curved styluses 30 of each input device 10 would extend inwardly towards each other and are arranged to be utilized simultaneously.

The mounting device 26 is formed of a rigid or semi-rigid material such as plastic, stamped or cast metal, acrylic, or any other suitable material that is safe for contact with human skin. The inside surface of the mounting device 26 could be formed of, surface treated with, e.g., providing grooves or nubs, or coated with a suitable tactile material, e.g., a suitable silicone, to increase gripping and adherence of the mounting device 26 upon the user's thumb to prevent slippage during use. The specific diameter, size and style of the mounting device 26 may be varied depending on the desired specifications of the user. The mounting device 26 may be a bracket or “expandable ring” which provides an open structure having a gap 40. The open structure allows the user to increase or decrease the size of the aperture 34 of the mounting device 12 to a desired size and to provide a degree of clamping pressure when worn on the user's thumb.

The stylus 30 extending from the mounting device 26 is shown in FIGS. 1-3. The stylus 30 is preferably curved in shape. The curved stylus 30 includes a base 42 which extends laterally from the mounting device 26 and an actuator portion 46, which extends at an angle of approximately ninety (90) degrees from the base 42 and points towards the interface of the handheld device. The actuator portion 46 is shown as extending for a short distance beyond the bottom surface of the user's thumb to assure that the thumb does not come into contact with the interface of the handheld device or otherwise interfere during use of the input device 10.

At the distal end of the actuator portion 46 are a series of projections 50. By way of example, as shown in FIGS. 1-3, there are four projections 50 extending from the actuator portion 46 towards the physical buttons 14 of the mobile phone 18. Each projection 50 narrows to a point as it extends from the actuator portion 46. By providing multiple projections 50, as opposed to a single projection, pressure is more evenly distributed across the surface area of a button 14 in the area where pressure is applied to increase the likelihood that the button 14 has been successfully actuated. For example, where pressure is applied at a single point to a remote corner of a button 14, the button 14 may not actuate. However, by utilizing multiple projections 50, a more even distribution of pressure is applied to the face of the button 14 which will increase the likelihood that the button will be actuated even when pressure is applied to the same remote corner of the button 14. In addition, utilizing multiple projections 50 reduces the possibility of creating marks, divots, or cavities in the buttons 14 during texting or typing. Further, by utilizing multiple projections 50, precise contact with buttons of a handheld device will be assured, reducing slippage, regardless of the buttons' shape or configuration. For example, due to the series of projections 50, the device 10 is equally suited for use on handheld devices where the buttons are greater in height than in width or where buttons are greater in width than in height, or other configurations, e.g., round buttons. Alternatively, the projections 50 could be formed of or surface-coated with a suitable tacky material or substance, e.g., rubber or silicone, to increase gripping contact with the buttons 14 during use.

Although the projections 50 preferably narrow as they extend from the actuator portion 46, they may also be circular, rectangular or any other shape which allows precise contact with the physical buttons or touch screen navigation buttons of a handheld device. The projections 50 are capable of actuating the buttons of a handheld device when the thumb mounting device 26 is mounted on either the right, the left thumb or both thumbs. The space between each projection 50 is a distance sufficient to prevent more than one physical button 14 or touch screen navigation button from being selected simultaneously during use.

For example, when the thumb-retained input device 10 is used to operate the physical buttons or touch screen navigation buttons of a handheld device such as a mobile phone or a PDA, one input device 10 is positioned on each thumb of the user so that the curved styluses 30 extend inwardly towards each other and the projections 50 extend towards the interface of the handheld device. The user then holds the hand held device with remaining fingers of both hands freeing the thumbs for use for typing or texting. The user then uses his thumbs to align the projections 50 with specific physical buttons or locations on the PDA screen. Because the projections 50 are laterally offset, the user's view of the physical or touch screen buttons is not obstructed or blocked by the thumbs during texting or typing.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

I claim:

1. A thumb-retained input device comprising:
a. a thumb-mounting device; and,
b. a curved stylus extending laterally from the thumb-mounting device and being oriented for effecting operative contact with an interface of a handheld device.

2. The thumb-retained input device of claim 1, wherein said interface is physical buttons of a handheld device.

3. The thumb-retained input device of claim 1, wherein said handheld device is a mobile phone.

4. The thumb-retained input device of claim 1, wherein said interface is a keypad, keyboard or navigation buttons depicted on the touch screen of a handheld device.

5. The thumb-retained input device of claim 4 wherein the handheld device is a personal digital assistant.

6. The thumb-retained input device of claim 1, wherein the thumb-mounting device is an open ring that partially wraps around the user's thumb, leaving an open gap.

7. The thumb-retained input device of claim 6, wherein said thumb mounting device is resilient to accommodate a variety of thumb sizes to provide a firm grip.

8. The thumb-retained input device of claim 1, wherein said input device is formed of a semi-rigid material selected from the group consisting of acrylic, plastic, stamped metal or cast metal.

9. The thumb-retained input device of claim 1, wherein said thumb mounting device is an open structure having a gap.

10. The thumb-retained input device of claim 1, wherein said curved stylus includes a tip end formed of a plurality of projections, said projections being sized and spaced from one another to enable accurate selection of physical buttons of a handheld device.

11. The thumb-retained input device of claim 4, wherein said curved stylus includes a tip end having a plurality of projections, said projections being sized and spaced from one another to enable accurate selection the navigation buttons depicted on the screen of a handheld device.

12. The thumb-retained input device of claim 10, wherein each said projection tapers towards a point.

13. The thumb-retained input device of claim 13, wherein said plurality of projections comprises four projections.

14. The thumb-retained input device of claim 10, wherein said plurality of projections is engaged with said second end by being integrally formed therewith.

15. The thumb-retained input device of claim 1, wherein said thumb mounting device includes an inside circumference having surface coated with or formed of a high-friction material for retaining a user's thumb within said circumference.

16. The thumb-retained input device of claim 1, wherein said device comprises a pair of devices arranged for wearing on the left and right thumbs of a user and arranged for simultaneous use.

17. The thumb-retained input device of claim 16, wherein said pair comprises a first input device arranged to be worn on a user's left thumb wherein said curved stylus extends laterally to the right and a second input device arranged to be worn on a user's right thumb wherein said curved stylus extends laterally to the left.
